(19) United States
(12) Patent Application Publication
(10) Pub. No.: US 2002/0128026 A1
(43) Pub. Date: Sep. 12, 2002

(54) System and method for channel prediction for closed loop diversity

(76) Inventors: Roy Thomas Derryberry, Plano, TX (US); Dumitru Mihai Ionescu, Dallas, TX (US); Balaji Raghothaman, Allen, TX (US)

Correspondence Address: JUBIN DANA, NOKIA INC., 6000 CONNECTION DRIVE, MD 1-4-755, IRVING, TX, 75039, US

(21) Appl. No.: 09/896,646

(22) Filed: Jun. 29, 2001

Related U.S. Application Data
(60) Provisional application No. 60/261,773, filed on Jan. 15, 2001.

(51) Int. Cl. H04B 7/005

(52) U.S. Cl. 455/504; 455/67.6; 455/67.1

(57) ABSTRACT

A system and method are provided for reducing the time delay associated with compensating for fading effects. The system includes a base station and a mobile station in communication. The base station transmits information and a pilot signal to the mobile station through each of the channels. The mobile station receives the information as noisy information and the pilot signal as a noisy pilot signal from each of the channels and compares the received noisy pilot signals to determine and predict a weight to be assigned to each of the channels. The calculated predicted weights are transmitted from the mobile station back to the base station as predicted feedback information that is utilized by the base station to alter the characteristics of the modulated carrier signal prior to transmission.

### BACKGROUND

This invention relates to communication systems and, more specifically, to wireless telecommunication systems.

Typical communication systems transmit information from one location or source to a second location or destination. The information travels from the source to the destination through a propagation medium. In a wireless system, this propagation medium typically induces fading, in addition to additive noise. Noise is defined herein to include any unwanted electrical signal received at the destination. Thus, the propagation medium introduces various forms of distortion. Accordingly, the signal that is transmitted through the propagation medium and received at a receiver is the transmitted signal containing the information as well as the introduced distortion by the propagation medium as a result of the signal travelling through the channel.

Information is carried by the signal, which is a carrier signal transmitted through the channel; the carrier signal is modulated to contain or carry the information. Various forms of modulation are used for transmission of the information through the channel. Modulation is the process of varying the characteristic of a carrier according to an established standard or scheme; the carrier is prepared or “modulated” in response to the information to produce a “modulated” carrier signal that is transmitted by the source to the destination through the channel. For example, in a cellular communication system, modulation is the process of varying the characteristics of the electrical carrier as information is being transmitted. The most common types of modulation are Frequency Modulation (FM), Amplitude Modulation (AM), and Phase Modulation (PM).

In a mobile telecommunications system, one type of noise that effects or alters the signal is called “fading”. More specifically, fading results from the reduction of the signal's intensity. The reduction is caused by factors such as reflection, refraction, and/or absorption of signal as the signal travels through the channel.

Compensating for the effects of fading is done using various techniques, such as transmit diversity techniques and methods. Transmit diversity methods fall into two classes: open loop methods and closed loop methods. A system that utilizes either one of the these methods has multiple antennas; these antennas are separated far enough so that the signal emerging from each antenna goes through a separate channel; thus, each carrier signal emerging from each antenna undergoes independent fading. Thus, at any given instant, the same information is used to modulate a several carrier signal, each of which travels through a different propagation medium from the source to the destination. The carrier signal is then transmitted by each of the antennas at a predetermined power level, which may be less than the transmission power of a single antenna system. Each carrier signal carries the same information, but travels through a different channel. Consequently, each carrier signal, which travels through one of the channels, will be impacted by the effects of fading in some way. It is unlikely that all of the channels will undergo deep fading effects simultaneously; as indicated above each carrier signal is assumed to undergo independent fadding. Accordingly, there will be at least one carrier signal carried by one channel, which contains the same information as all of the other carrier signals emerging from the base station, that is less impacted by the effects of fading at that instant in time compared to the other carrier signals propagating through other channels. Current methods of compensating for fading, which using either open or closed loop methods, alter transmission characteristics, such as power levels, to compensate for the effects of fading.

There are differences between open and closed loop systems that lead to various advantages when using one technique instead of the other. For example, in the closed loop system the receiver, such as the mobile station, provides feedback to the transmitter, such as a base station. On the other hand, in the open loop system the transmitter does not receive feedback from the receiver. More specifically, in the closed loop systems the mobile station provides feedback to the base station that relating to the power and phase of each carrier signal associated with each channel. In response to the feedback received, the base station varies the transmission characteristics of each carrier signal associate with each antenna to obtain optimal carrier signal response at the receiver is response to the feedback.

One problem with current solutions is the delay in responding to the feedback, especially for rapidly fading channels. For example, from the time the mobile station sends the feedback until the time the base station receives the feedback and then alters the transmission characteristics of the carrier signal and the altered carrier signal is received at the mobile station again a finite amount of time has lapsed. This lapse in time can cause a problem.

In some instances the lapsed time is not a concern. For example, when the mobile station is moving very slowly or is displaced a small distance during the delay period; the delay or time lapse will have less of an impact on the effectiveness of the alteration in the transmitted carrier signal. However, when the mobile station is moving fast, such as a mobile station in a vehicle, or a great geographical displacement takes place over a short period of time, and then the time delay significantly impacts the effectiveness of the feedback because the mobile station is moving to a new environment where the fading characteristics are different. Accordingly, the feedback, upon which the base station relies to alter the transmission characteristics of the carrier signal, does not reflect the fading characteristics present at the mobile station when the adjusted carrier signal is again received at the receiver or destination.

Therefore, what is needed is a system and method for reducing the time delay associated with adapting the transmitted signal to overcome the effects of fading associated as well as improve the over system response to compensating for fading effects.

### SUMMARY

A system and method are taught and disclosed for reducing the time delay associated with adapting the transmitted signal from a base station to the mobile station that overcomes the effects of fading associated as well as improve the over system response to compensating for fading effects.

The system includes at least one base station for modulating a carrier signal in response to a data stream received at the base station and transmitting the modulated carrier signal through at least two distinct channels to at least one mobile station that is in communication with the base station. The modulate carrier signal is received as a noisy modulated carrier signal that is effected by propagation medium fading and is demodulated to recover that data.

Additionally, the base station also transmits a pilot signal to the mobile station through each of the channels. The mobile station receives the pilot signal as a noisy pilot signal from each of the channels and compares the received noisy pilot signals to determine and predict a weight to be assigned to each of the channels. The calculated predicted weights are transmitted from the mobile station back to the base station as predicted feedback information that is utilized by the base station to alter the characteristics of the modulated carrier signal prior to transmission.

### BRIEF DESCRIPTION OF THE DRAWINGS

FIG. 1 is a block diagram of a system utilising fading prediction techniques in accordance with the teachings set forth herein.

FIG. 2 is a block diagram of a base station.

FIG. 3 is a block diagram of a mobile station.

FIG. 4 is a flow chart for prediction of propagation medium measurements to provide feedback in accordance with the present invention.

### DETAILED DESCRIPTION

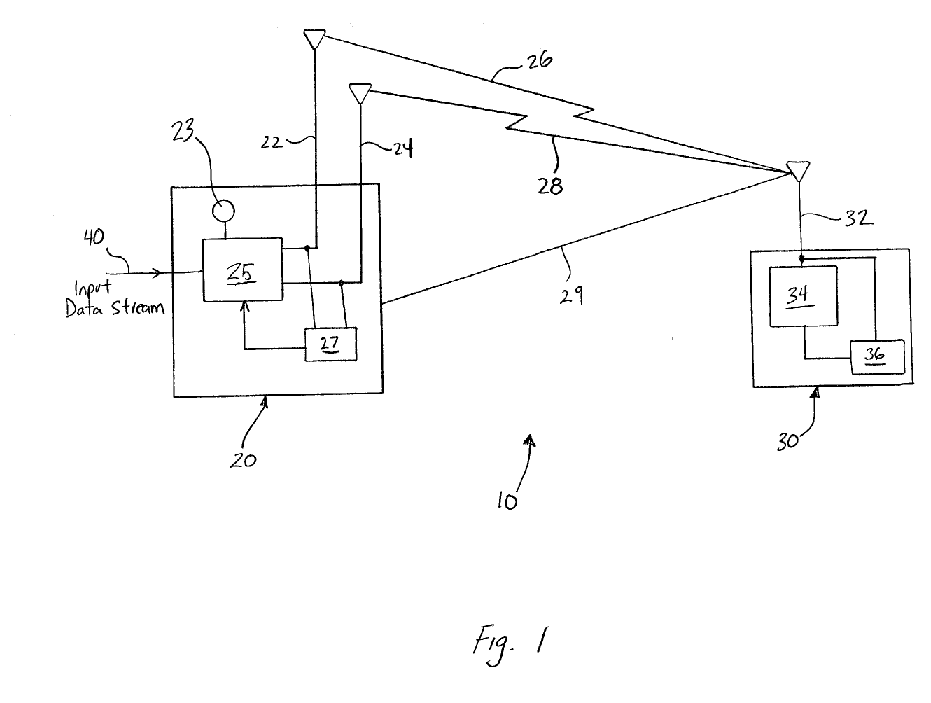

Referring now to FIG. 1, a system 10 includes a base station 20 in communication with at least one mobile station 30. The base station 20 for transmission, using antennas 22 and 24, to the mobile station 30, which has an antenna 32, receives a data stream 40. It will be apparent to those skilled in the art that the paths from the two antennas 22 and 24 are closely spaced in time of arrival at the mobile station 30.

The mobile station 30 also includes a modulation/demodulation unit 34 for receiving the modulated carried signal and demodulating the modulated carrier signal to recover the data stream 40. Additionally the unit 34 can also modulate data streams for transmission to the base station 20.

The mobile station 30 also includes a feedback unit 36 for providing feedback, in accordance with the teachings of the present invention, to the base station 20, as discussed below, to overcome the effects of fading.

The data stream 40 that arrives at the base station 20 can originate from a number of sources including data being transmitted from another mobile user, a server, the Internet, or a Public Switch Telephone Network (PSTN). The data stream 40 can have any number of origins and the scope of the invention set forth herein is not limited thereby.

Antennas 22 and 24 are spatially separated to created two distinct channels as discussed herein. For illustrative purposes, the base station 20 is shown with only two antennas. However, the scope of the teachings set forth and claimed herein is not limited thereby. The teachings set forth herein can be extended, without undue experimentation, to the case of a base station having “M” antennas that are spatially separated, wherein M is greater than 2 (M>2).

In the system 10, the base station 20 a processor unit 25. The processor unit 25 is coupled to the input and receives the data stream 40. The processor unit 25 receives the data stream 40 and modulates a carrier signal to carry the data stream 40. Modulation is the process of altering the characteristics of a carrier signal, wherein the alteration of the carrier signal corresponds or represents the data stream that is to be carried from one location to another. There are many forms of modulation, and the scope of the teachings set forth herein is not limited thereby.

Once the carrier signal is ready for transmission s the modulated carrier signal, the modulated carrier signal is transmitted to the mobile station 30 via the antennas 22 and 24. The base station 20 transmits the modulated carrier signal containing the data stream 40 through two channels or media 26 and 28 using antennas 22 and 24. With regard to fading, the intended meaning of the term channel is generic and can include a propagation medium as an environment for establishing communication in a wireless communication system. For example, communication can be established through air and water. Thus, the scope of the teachings set forth herein is not limited by the phrase utilized to refer to the communication link.

Accordingly, the same modulated carrier signal emerges from the base station 20 and travels to the mobile station 30 through the two channels 26 and 28. The channels 26 and 28 are represented as h₁(t), h₂(t), respectively. The antenna weights are designated to be w₁(t), w₂(t) for the channels 26 and 28, respectively.

Once the modulated carrier signal is received at the mobile station 30, the unit 34 demodulates the modulated carries signal to recover the data stream. The modulate carrier signal is received from each of the channels 26 and 28 and includes various forms of noise, including the effects of fading. However, given that there are two paths and that each path will have different fading effects, there is a difference in the characteristics of the two modulated carrier signal received at the mobile station 30. Based on this difference, the unit 36 can determine feedback information, as discussed below, that can be provided to send to the base station 20.

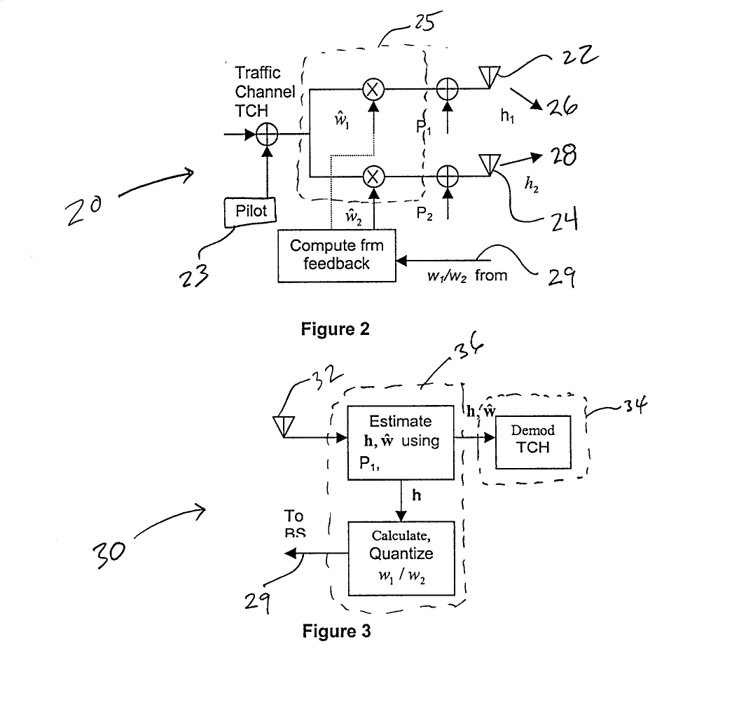

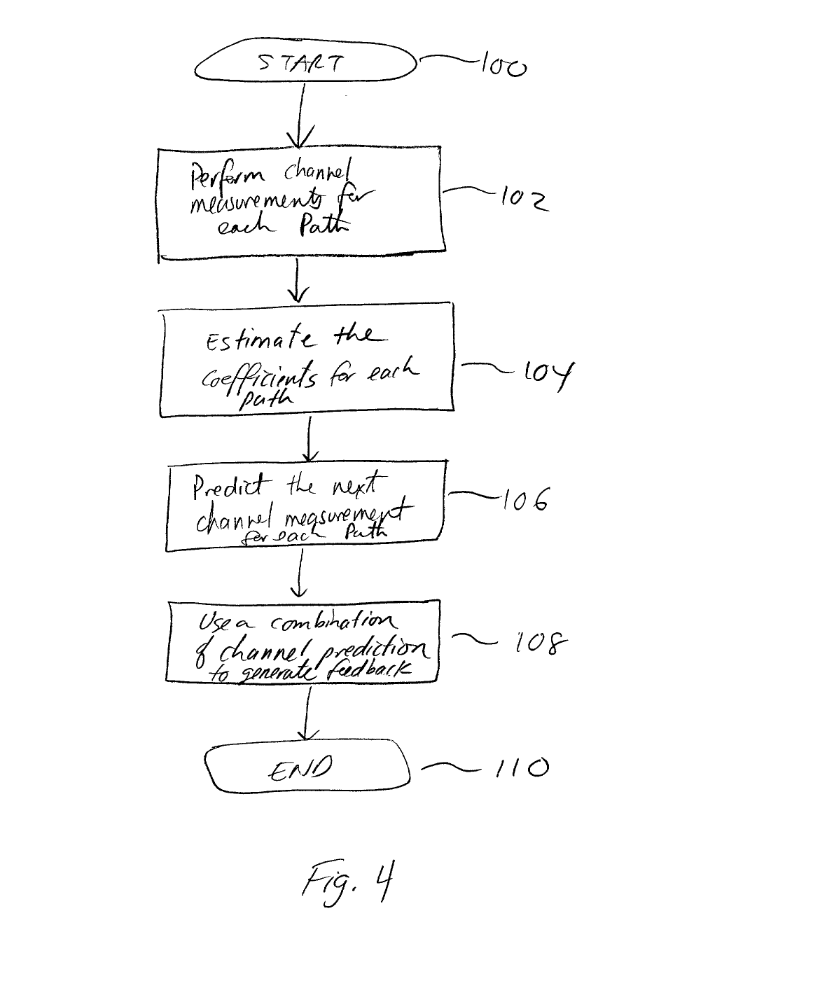

Referring now to FIGS. 2 and 3, in one embodiment, a technique called Transmit Adaptive Array (TXAA) is utilized. TXAA is a technique that includes the mobile station 30 sending quantized estimates of the downlink channel, or feedback, to the base station 20. The base station 20 uses this information to assign a weight to the transmitted modulated carrier signal, which is optimized to deliver maximum power in light of the fading condition at the mobile station 30. These weights, w, are calculated by the mobile station 30 at periodic intervals from the information obtained through the two strong pilot signals P₁ and P₂. The pilot signals P₁ and P₂ being transmitted through each of the channels are identical pilot signals prior to transmission from the base station 20. These identical pilot signals P₁ and P₂ travel through two different channels 26 and 28, respectively. Accordingly, the pilot signals P₁ and P₂ arrive at the mobile station 30 with different characteristics representing, in part, the effects of fading on each of the respective channels.

Using the received pilot signals, the mobile station can determine the weights accorded to each channel. These weights are quantized and then provided as feedback to the base station 20 on the reverse link control channel. It is assumed that the weights will be calculated every Power Control Group (PCG) and, hence, there will be a PCG delay in the feedback. Accordingly, there is a delay between the feedback and its actual application on the forward link channels 26 and 28. Hence, the weights are calculated at PCG p, fed back at PCG p+1, and utilized at PCG p+2. Ignoring the time subscripts, the signal received at the mobile station 30 will be represented by:

$$\begin{matrix}y = [ \begin{matrix}{h}_{1} & {h}_{2} ] [ \begin{matrix}{w}_{1} \\ {w}_{2}\end{matrix} ] x + γ\end{matrix} \\ = h w x + γ ,\end{matrix} \qquad ( 1 )$$

where γ refers to the additive noise. For maximal ratio combining at the mobile station 30, the conjugate of the weights, as seen by the mobile station 30, are applied. Thus, the recovered signal, which is data stream 40 as recovered from the received modulated carrier signal by the mobile station 30, is given by:

ŷ=w^{H}h^{H}hwx+\hat{γ}. (2)

In order to maximize the received signal power, the value of w^{H}h^{H}hw has to be maximized. The weights that maximize this expression are given by:

arg(max w^{H}h^{H}hw)=h^{H}. (3)

That is to say, the optimal weights are given by the conjugate of the coefficients of the channels 26 and 28. The weights have to be normalized so that the total transmitted energy is not altered. Hence, the optimal weights are given by:

$$w = \frac{{h}^{H}}{h {h}^{H}} . \qquad ( 4 )$$

In the case of multipath channels emanating from each of the antennas, wherein h is a matrix instead of a vector, the optimal weights will be given by the principal eigenvector of the propagation medium correlation matrix h^{H}h.

The channels can be modelled as an autoregressive process. Noting that h is the propagation medium response estimated by the mobile station 30, the autoregressive model can be expressed for each channel component, i, at discrete time instant n, as follows:

$${h}_{i} ( n ) = {\sum }_{k = 1}^{K} {a}_{i} ( k ) {h}_{i} ( n - k ) + u ( n ) \qquad ( 5 )$$

where K is the order of the autoregressive model, a(k) is the model coefficients or taps, and u(n) is the model process noise. The estimation of a(k) can be performed in several ways, via spectral autoregressive estimation methods or adaptive methods and the scope of the teachings set forth herein is not limited thereby. It is apparent to those skilled in the art that prediction cannot be perfect; thus, there is a process of correction or adaptation based on the prediction error, e(n), defined as:

eᵢ(n)=hᵢ(n)−ĥᵢ(n) (6)

As an example the least mean-square (LMS) algorithm performs model tap estimation based on the prediction error or residual signal generated by the autoregressive process as follows

aᵢ_{ₙ₊₁}(k)=aᵢ_{ₙ}(k)+μeᵢ(n)hᵢ(n−k) (7)

where n denotes the n^{th} time update of the coefficient and μ is the adaptation step size.

Each of the channels 26 and 28 are time-varying channels that have mobily altering characteristics. The base-band representation of these time-varying channels is generated as the sum of complex exponentials with random phases and delays as shown below:

$$h i ( τ , t ) = {lim}_{N \to ∞} \frac{1}{\sqrt{N}} {\sum }_{k = 1}^{N} {ⅇ}^{j ( {ϑ}_{k} + 2 π {f}_{{d}_{i}} t )} δ ( t - {τ}_{k} ) \qquad ( 8 )$$

where θₖ and f_{d, i} are the random phase uniformly distributed over (0, 2π) and the Doppler frequency distribution, and τₖ is the delay respectively. This model generates realizations of a Rayleigh faded channel. An adaptive predictor based on the normalized LMS algorithm is used to predict the channel.

Referring now to FIG. 4, the process of predicting channel feedback beings at step 100. At step 102, channel measurements are performed for each channel path, h_{i.}. At step 104, the channel measurements are used to estimate the autoregressive coefficients for each channel path. At step 106, the next channel measurements for each path are predicted using the estimated autoregressive coefficients for each path. At step 108, a feedback command is generated using a combination of the predicted channel measurements for each channel path.

Although described in the context of particular embodiments, it will be apparent to those skilled in the art that a number of modifications to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A communication system comprising:
at least one base station for modulating a carrier signal in response to a data stream, which is to be transmitted by the base station, in order to produce a modulated carrier signal and transmit the modulated carrier signal through at least two distinct propagation media; and
at least one mobile station in communication with the base station for receiving the modulate carrier signal, which undergoes distortion due to propagation through a medium, as a distorted carrier signal through the at least two media and demodulating the distorted signal to recover the data stream,
wherein distinct pilot signals, known by the mobile station, are transmitted to the mobile station by the base station through each of the propagation media, and the mobile station receives the pilot signals as distorted pilot signals through each of the propagation media, then compares the received distorted pilot signals to determine and predict propagation measurements, and wherein feedback information, which is determined therefrom, is transmitted from the mobile station to the base station, then utilized by the base station to alter the characteristics of the modulated carrier signal prior to transmission.

2. The system of claim 1, wherein the base station further comprises:
at least two antennas coupled to the respective media;
a transmission unit coupled to the respective antennas, wherein the transmission unit receives the data stream and modulates the carrier signal to produce the modulated carrier signal; and
a calculation unit coupled to the transmission unit and the at least two antennas for receiving the feedback information from the mobile station, and modulated carrier signals being transmitted over each of the media are weighted.

3. The system of claim 2, wherein the base station transmits a distinct pilot signal to the mobile station via each of the at least two antennas.

4. The system of claim 3, wherein the predicted feedback information is transmitted from the mobile station to the base station via a feedback channel.

5. A method for providing feedback from a mobile station to a base station base on predicted information, the method comprising:
performing propagation measurements for a plurality of propagation media;
estimating a representative value for each of the at least two propagation media based on the propagation measurements;
performing prediction of future propagation measurements for each of the plurality of propagation media; and
generating the feedback information based on prediction of future propagation measurements.

6. The method of claim 5, further comprising conveying the feedback information to the base station using a feedback channel.
